(19) United States
(12) Patent Application Publication
(10) Pub. No.: US 2011/0041308 A1
(43) Pub. Date: Feb. 24, 2011

(54) Erodible Spacer Dicing Blade Gang Assembly

(75) Inventors: Kent A. Swanson, Ventura, CA (US); William J. Abeyta, Port Hueneme, CA (US); Serapion Doaf, Moorpark, CA (US)

Correspondence Address: WOOD, HERRON & EVANS, LLP, 2700 CAREW TOWER, 441 VINE STREET, CINCINNATI, OH, 45202, US

(73) Assignee: VEECO INSTRUMENTS, INC., Plainview, NY (US)

(21) Appl. No.: 12/546,146

(22) Filed: Aug. 24, 2009

(51) Int. Cl. B23P 15/28

(52) U.S. Cl. 29/428

(57) ABSTRACT

A ganged saw blade assembly for dicing of wafers includes a plurality of circular saw blades positioned along a common central axis and erodible pitch spacers positioned along the common central axis between adjacent saw blades. The pitch spacers are eroded to a desired diameter relative to the common central axis to maintain a desired saw exposure, e.g. by sawing into an abrasive material with the saw blade assembly. The saw blade assembly thus permits use of the saw blades over longer periods notwithstanding erosion of the blades.

### FIELD OF THE INVENTION

The present invention generally relates to assemblies of rotary saw blades for the semiconductor industry.

### BACKGROUND

In the making of electrical components from semiconductor materials and the like, multiple patterns are produced on a substrate that is subsequently sawed into smaller portions. The saws on which this is done are generally termed “dicing saws”. The circular blades used in such a saw are made of abrasive materials, for example, pieces of diamond held in a resin, CBN abrasive, or electrolytically deposited (electroformed) nickel bond matrix. The saw blades are thin so that they have a small width of cut, and thereby waste less material and generate less heat. But when a saw blade is thin it needs support near the outer edge where it is cutting. This support must be supplied without interfering with the planned cutting task. One way to provide support is to use a round disk of a smaller diameter than the blade. As an example, a saw blade of 2 inch diameter may be adjacent to and in contact with a support of 1.7 inch diameter, so that the blade can cut into a substrate to a depth of 0.1 inch, while still having a 0.05 inch clearance between the support and the substrate. In the example: (2−1.7)/2−0.1=0.05. In this example, 0.15 inches is known as the “blade exposure” or “cutting edge”.

As an example of prior art, FIG. 1 illustrates a ganged cutter assembly 2 having a hub body 4 with a bore 6 that precisely fits on a pilot 8 of a rotating spindle 10 and is secured by a spindle nut 12. In this example, there is no key-way or similar feature for torque transmission. The friction between the squeezed faces of the cutter assembly 2 and the spindle 10 is sufficient to prevent slippage. The ganged cutter assembly 2 has blades 14 and spacers 16 arranged and squeezed in place on a shoulder 18 by an outer flange 20 fastened with bolts 22. The spacers 16 provide the support previously described. Multiple copies of the cutter assembly 2 would typically be assembled and stocked by a tool room of a manufacturing facility, so they could be brought to a dicing machine as the previous cutter assembly becomes worn and needs replacement. It is not usually blade dullness that dictates blade cutter assembly replacement. The blades are usually made of diamonds or other particles impregnated into a bonding material. As a diamond particle becomes dull, the cutting forces acting on it increase and it is pulled from the bonding material so that new diamond particles become exposed to keep the blades sharp. However, this process means a continual decrease in the diameter of the blades. As the abrasive blade wears, its diameter becomes smaller while the adjacent spacer diameter remains the same. The spacers are typically manufactured from hard materials that resist wear, for example hardened stainless steel or aluminum-oxide ceramic. Eventually, in attempting to perform the intended cut, the spacer contacts the substrate surface. This can damage the substrate and the saw. Prior to this degree of wear, the sawing process must be stopped and a new cutter assembly put on the spindle and the old one returned to the tool room. Back in the tool room, the blade exposure can be returned to a sufficient depth by either replacing the abrasive blade with a new one, or installing a smaller diameter spacer and continuing with the same blades. This process causes down time for the saw, increased labor costs, and the need to stock spacers of various diameters.

There are at least two kinds of dicing saws. The kind with a single supported blade, for example those disclosed in U.S. Pat. No. 5,261,385 to Kroll, that must do multiple passes across a substrate to achieve multiple cuts, and a ganged set of blades (as seen in FIG. 1). Ganged sets of blades are blades that are on a common axis and spaced apart from one another by spacers. In many cases, the spacers also provide support. In this application, the nouns “support” and “spacer” may be used interchangeably to refer to the same piece of hardware. While gang blade assemblies provide a multi-fold increase in machine efficiency and throughput, a notable portion of tool cost is the labor involved to stack the assembly. This cost reduces price-competitiveness compared with a single-blade process model, which does not require a stacking procedure.

When a gang blade assembly is stacked for the first time, using freshly manufactured blades and spacers, the parts are usually free of warpage and stacking is not too difficult. However, after use, when re-stacking is needed with smaller spacers, the blades and previously used spacers are often found to be warped, making stacking more difficult. In an effort to get the least measured run-out, it is often necessary to angularly change (this process is commonly known as clocking) the blades and spacers relative to each other many times while measuring the run-out.

If the frequency of re-stacking procedures can be reduced then the gang blade assemblies will require less labor to use and will be more cost competitive.

One way to reduce the frequency of re-stacks is to machine or erode the spacers to a smaller diameter without unstacking them from the blades. If the spacers are of a hard material this could be difficult. But, it is known, to provide spacers of a softer material that can be eroded away relatively easily, by purposefully contacting it with a hard dressing material. Further, if the dressing material is substantially softer than the blades, then the blades can cut into the dressing material with no harm done. If desired, the dressing material can be specifically chosen to “dress” the blades, (i.e., selectively remove the blade bonding material to expose fresh particles). Such a process of eroding the spacers is described in U.S. Pat. No. 5,261,385 to Kroll, for single blade dicing saws. However, it is desirable to use erodible spacers in a ganged saw assembly to achieve even greater efficiencies.

### SUMMARY OF THE INVENTION

In accordance with principles of the present invention, a marked improvement is accomplished in the allowable blade wear in a ganged saw blade assembly, such as a gang saw for dicing of wafers. This is accomplished by constructing the gang saw of saw blades separated by erodible pitch spacers. As the saw blades erode during use, the pitch spacers may be eroded in a controlled, matching fashion, e.g. by pausing the use of the tool and sawing into an abrasive material with the saw blade assembly at a controlled cut depth that abrades the pitch spacers so as to return the saw blades to the desired exposure.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention.

FIG. 1 is an exploded perspective view of a ganged dicing saw assembly of the prior art and a spindle to which it attaches.

FIGS. 2A-2C illustrate an embodiment of a ganged dicing saw assembly being stacked on an assembly tool, and then in its final form.

FIG. 3 illustrates an assembled view of the ganged dicing saw embodiment of FIG. 2C in cross-section on a partially cross-sectioned spindle assembly on a spindle.

FIG. 3A is a detailed view as indicated in FIG. 3.

FIG. 4 illustrates the embodiment of FIGS. 2C and 3 being brought to an abrasive block for a blade dressing and erosion sequence.

FIG. 5A is a detail view as indicated in FIG. 4, of a ganged assembly before erosion and dressing.

FIG. 5B is the detail view of FIG. 5A after erosion and dressing.

### DETAILED DESCRIPTION

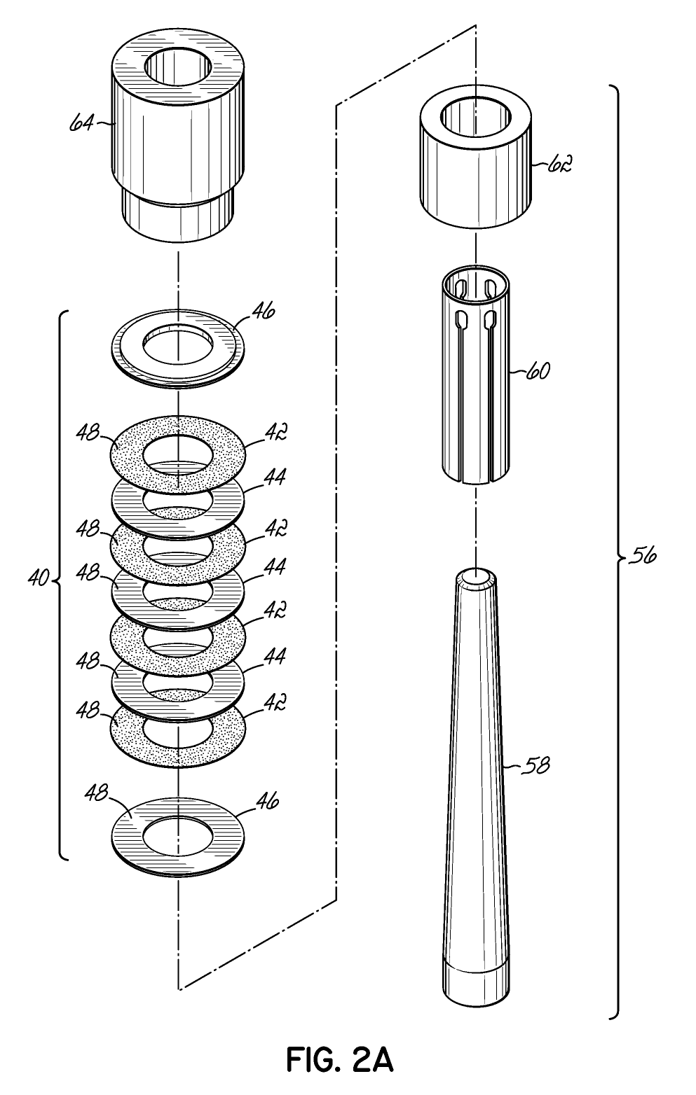

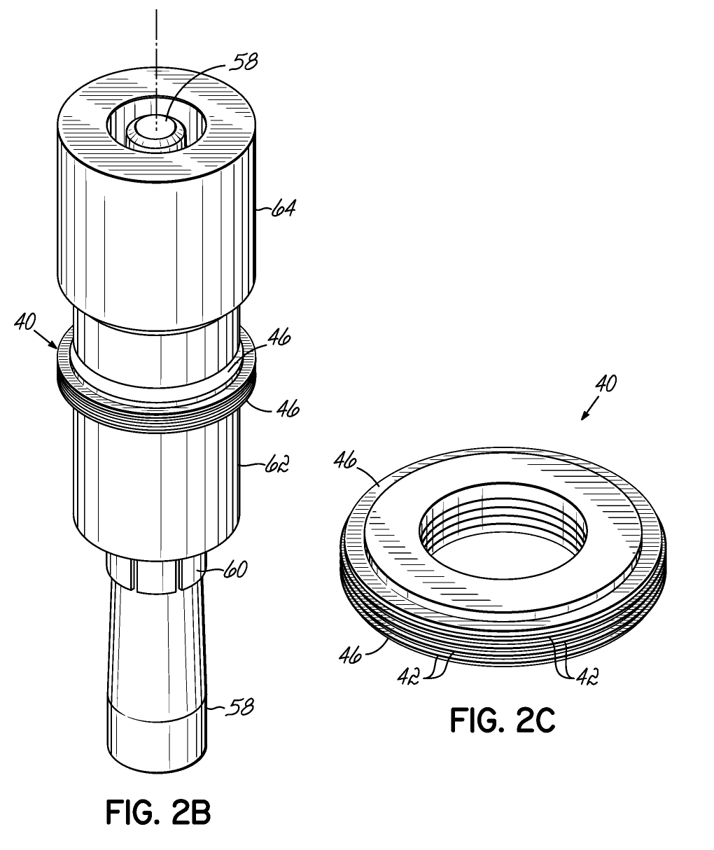

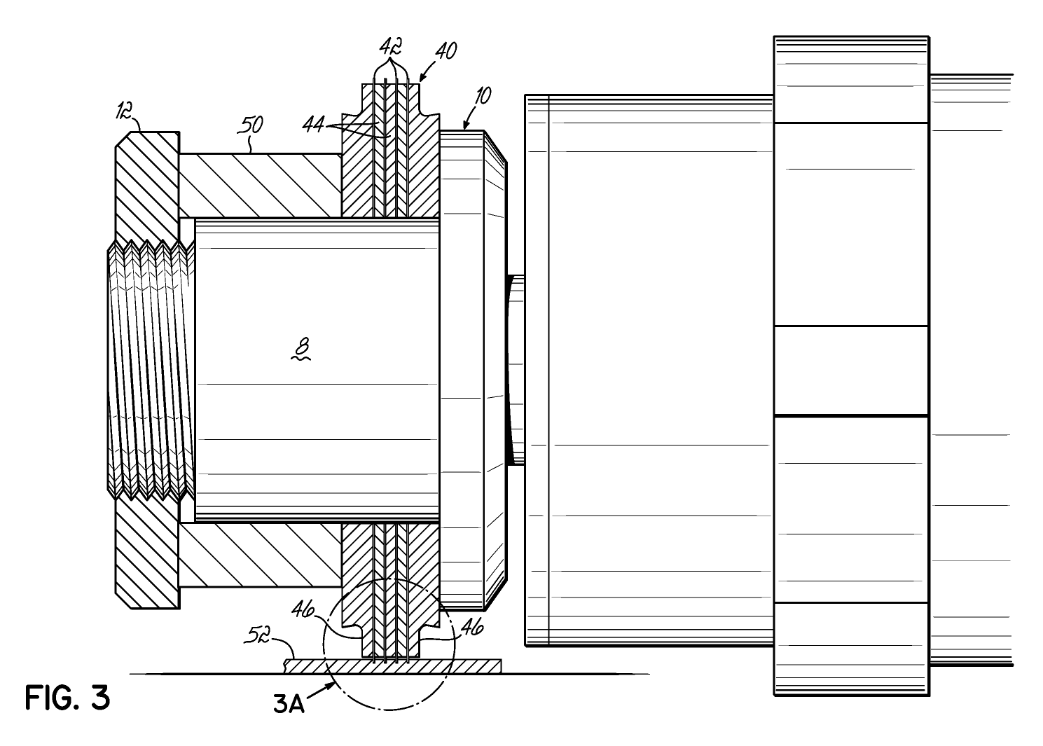

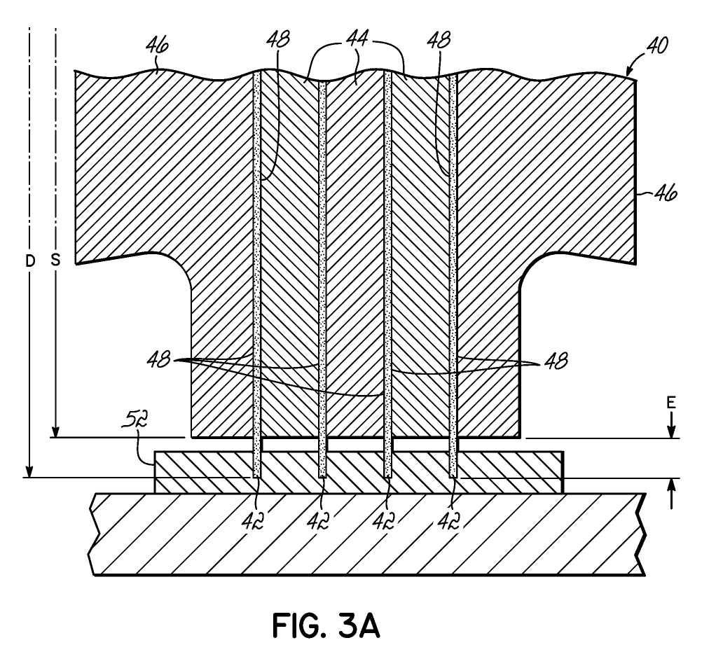

FIGS. 2 and 2B illustrate an embodiment of a gang cutter 40 of the current design being assembled from blades 42, pitch spacers 44, and end spacers 46. The embodiment does not use a hub body 4, flange 20, or bolts 22. Instead the blades 42 and spacers 44, 46 are held together by adhesive 48. The adhesive 48 need not be strong enough to transmit the cutting torque during use because as illustrated in FIG. 3, the gang cutter 40 will be squeezed on the spindle 10 by the spindle nut 12 acting through a clamp spacer 50, so mechanical friction between adjacent spacers 44, 46 and blades 42 will transmit torque even without the adhesive 48 remaining bonded. However, the invention is not so limited, and in some embodiments adhesives or other bonding techniques may provide the only torque transmission path.

As seen in FIGS. 3 and 3A, the gang cutter 40 has blades 42 of an outside diameter designated D, and the pitch spacers 44 and flange spacers 46 have an outside diameter designated S. A gang cutter 40 setup like this is said to have an exposure (E) calculated as E=(D−S)/2. As seen in FIG. 3A, as the gang cutter 40 is brought in to a cutting relationship with a workpiece 52 it can theoretically cut through, or cut a groove to a depth equal to E. However in practice, clearance for coolant flow and debris flushing should be considered, so that actual maximum cut depth may be less than E.

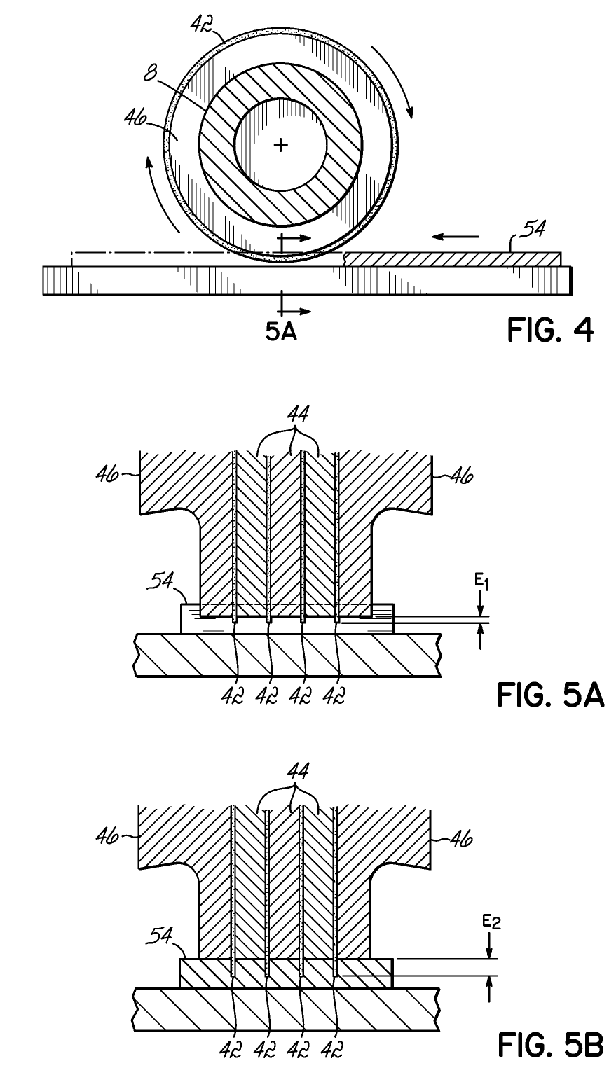

As explained in the background, as the blade 42 wears, D decreases while S remains constant, except for minor erosion from cutting fluid and debris. This causes E to decrease, and it is a limiting factor as to how long production can continue. In the present invention, the spacers 44,46 are made of an easily abraded material such as a plastic composite, or a molded/extruded/pressed graphite, or a pressed graphite, or a combination of these or any suitable material. They may be bisque-fired (i.e. partially-fused) ceramic. When E decreases to a limit, for example an E₁ (FIG. 5A), before the next workpiece 52 is cut a dressing block 54 is put in place of the workpiece 52 as seen in FIG. 4. The dressing block 54 is made of an abrasive material that is harder than the pitch spacers 44 and the flange spacers 46, but significantly softer than the blades 42. By simply cutting into the dressing block 54 to a depth, for example E₂, the pitch spacers 44 and the flange spacers 46 will be eroded away and the exposure will at that time be E₂ (FIG. 5B). Then production cutting may resume. Advantageously, if the blades 42 require a dressing pass to sharpen or hone them, as many do, the dressing block 54 may be chosen to accomplish the sharpening or honing at the same time.

The exposure E is a critical parameter in thin-blade, precision slicing/dicing operations. Maximum exposure to thickness ratios have been empirically developed by the assignee of this application, based upon the bond composition (and stiffness) of the blade.

There are three fundamental bond types used in the dicing saw industry (in order of increasing stiffness—i.e. elastic modulus): resinoid, sintered metal and electroformed Ni. Experience has led to the use of the following maximum aspect ratios:

| | Maximum |
|---|---|
| Blade Bond Type | Exposure:Thickness ratio |
| resin | 10:1 |
| Metal | 20:1 |
| Ni | 30:1 |

To assure that the above concept is understood, an example calculation is as follows: A blade that is 0.010 inches thick and 2 inch diameter is adjacent spacers that are 1.700 diameter, of any thickness. Then, E=(2−1.7)/2=0.150, and the ratio is 0.150/0.010=15:1, so this combination would be acceptable blade exposure for blades 42 made of metal or Ni, but not for blades 42 made of a resin.

An advantage of the erodible spacer concept is that maximization of initial exposure will not be required in order to maximize blade life. For example, it will only be necessary to erode the spacers enough to expose an additional 0.010″−0.015″ beyond the required cut depth. This means that cuts can be more precise and cutting speeds and production increased on a consistent basis. It also means that whereas the economics of cutter assembly life may have previously led to the use of a long blade exposure and therefore a metal or Ni blade, now it is possible to use the less expensive resin blades 42.

Referring again to FIGS. 2A-2C, the stacking fixture 56 and its method of use will be explained. A tapered post 58 receives an expanding mandrel 60. A stacking spacer 62, blades 42, pitch spacers 44 and the flange spacers 46, are stacked to surround the expanding mandrel 60. Adhesive 48, for example a polyvinyl acetate (PVA) is put between the blades 42, pitch spacers 44, and flange spacers 46 as they are stacked. The adhesive 48 is sized to spread out in a fine layer and enter the porous areas of the blades 42, pitch spacers 44 and flange spacers 46 so that excess adhesive 48 does not affect the overall stack of the gang cutter 40. If necessary, relief areas (not shown) may be included in the pitch spacers 44 and the flange spacers 46 to make space for excess adhesive 48. As an alternative, a suitable adhesive may be pre-applied to some or all of the spacers or blades, and then activated in a suitable process, such as for example, by heat, pressure, radiation, etc. A downward force on the stack moves the expanding mandrel 60 down the tapered post 58 so that the expanding mandrel 60 expands and engages the inside diameter of the flange spacers 46, pitch spacers 44, and blades 42 to align them. The stacking spacer 62 is sized to limit the diametral expansion of the expanding mandrel 60 so that excess force cannot be applied to the inside diameters of the blades 42, pitch spacers 44, and the flange spacers 46. A weight 64 or another way to supply compression is left in place while the adhesive 48 cures. FIG. 2C shows the gang cutter 40 after it has been removed from the stacking fixture 56, ready to be installed as in FIG. 3.

Although the embodiments described have pitch spacers 44 of all the same thickness, and flange spacers 46 that are flanged, any combination and quantity of spacers may be used. The flanged spacers provide another surface to grip while handling the gang cutter 40, which is especially beneficial for small sizes.

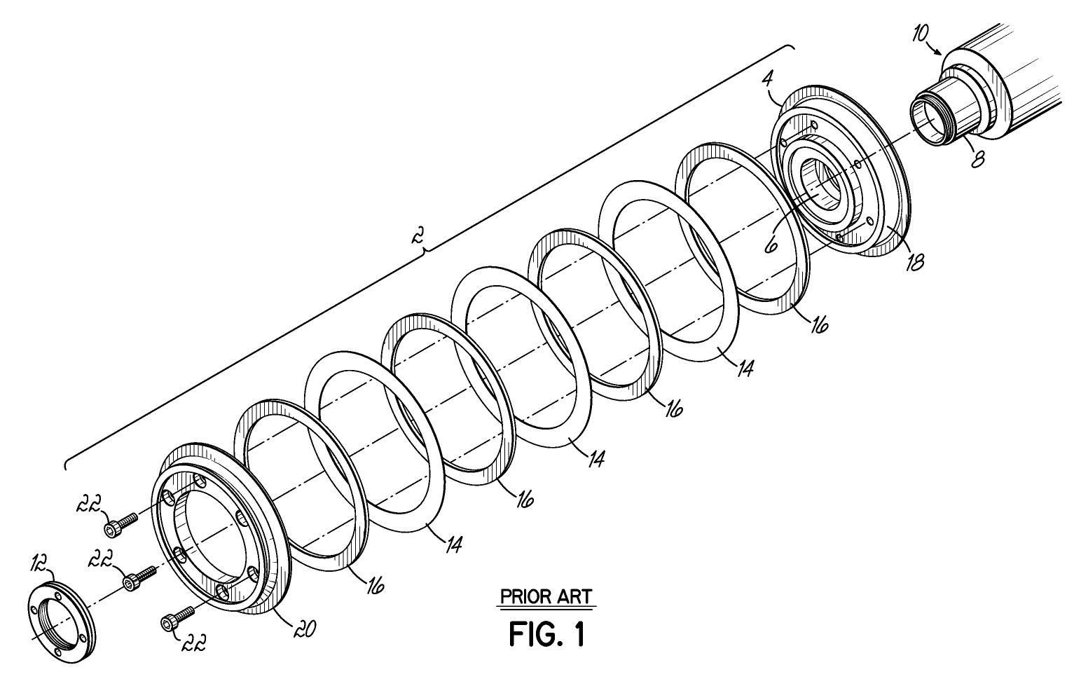

The embodiment described in FIGS. 2A-5B uses adhesive 48 rather than the hub body 4, flange 20, and bolts 22 of the prior art FIG. 1. However, it is contemplated that erodible spacers can also be used in embodiments that use the hub body 4 and flange 20 and bolts 22 of FIG. 1. This may be for new designs, or for existing equipment already in use. Any limitations caused by the largest diameters of the hub body 4 and forward flanges must be considered because the smaller the blades 42 and spacers become, the more the hub body 4 and flange 20 will protrude.

The table below lists some typical blade OD/ID/thickness dimensions. However, note that these are examples, and the possible OD/ID/thickness combinations are not limited to this list. The table also includes the associated pitch spacer thicknesses that might be included in a gang. Spacer OD would associate with required exposure and that exposure could range from zero to approximately the max ratio allowed by the blade bond type, which may change as materials and processes improve. The last column, containing a special symbol, is to identify some sizes that are expected to be a commonly used size.

| Blade | | | | | | Pitch Spacer | | |
|---|---|---|---|---|---|---|---|---|
| OD | | ID | | Thks | | Thks | | |
| 2.000-2.188″ | | .750″ | | .0006-.012″ | | .020-.080″ | | * |
| 50.80-55.56 mm | | 19.05 | mm | .015-.300 | mm | .500-2.000 | mm | |
| 3.000″ | | 1.250″ | | .0006-.012″ | | .020-.080″ | | |
| 76.2 | mm | 31.75 | mm | .015-.300 | mm | .500-2.000 | mm | |
| 3.000″ | | 1.575″ | | .0006-.012″ | | .020-.080″ | | * |
| 76.2 | mm | 40.00 | mm | .015-.300 | mm | .500-2.000 | mm | |
| 4.000″ | | 2.047″ | | .0012-.050″ | | .040-.500″ | | |
| 101.6 | mm | 52.00 | mm | .030-1.270 | mm | 1.000-12.700 | mm | |
| 4.300″ | | 3.500″ | | .0024-.050″ | | .040-.500″ | | |
| 109.22 | mm | 88.90 | mm | .060-.270 | mm | 1.000-12.700 | mm | |
| 4.400″ | | 3.500″ | | .0024-.050″ | | .040-.500″ | | |
| 111.76 | mm | 88.90 | mm | .060-1.270 | mm | 1.000-12.700 | mm | |
| 4.500″ | | 3.500″ | | .0024-.050″ | | .040-.500″ | | * |
| 114.30 | mm | 88.90 | mm | .060-1.270 | mm | 1.000-12.700 | mm | |
| 4.600″ | | 3.500″ | | .0024-.050″ | | .040-.500″ | | |
| 116.84 | mm | 88.90 | mm | .060-1.270 | mm | 1.000-12.700 | mm | |
| 5.000″ | | 3.500″ | | .005-.050″ | | .040-.500″ | | |
| 127.00 | mm | 88.90 | mm | .127-1.270 | mm | 1.000-12.700 | mm | |

The invention has been described herein with reference to specific embodiments, and those embodiments have been explained in substantial detail. However, the principles of the present invention are not limited to such details which have been provided for exemplary purposes.

What is claimed is:

1. A method of preparing a ganged saw blade assembly for use, comprising:
providing a plurality of circular saw blades positioned along a common central axis;
providing a plurality of erodible pitch spacers positioned along the common central axis with at least one of the erodible pitch spacers between adjacent circular saw blades; and
eroding the pitch spacers to a desired diameter relative to the common central axis by sawing into an abrasive material with the saw blade assembly, to a depth that causes abrasion of the pitch spacers.

2. The method of claim 1 further comprising assembling a hub, outer flange, and fasteners to squeeze the circular saw blades and erodible pitch spacers into the ganged saw assembly that is then mountable to a spindle.

3. The method of claim 1 further comprising curing an adhesive to hold the spacers and circular saw blades in an assembly configuration that is directly mountable to a spindle.

4. The method of claim 3 wherein the circular saw blades have an outside diameter of between approximately two and 4.5 inches.

5. The method of claim 3 wherein the circular saw blades have an inside diameter of between approximately 0.750 inch inside and 3.5 inches.

6. The method of claim 3 wherein the circular saw blades have a thickness between approximately 0.0006 and 0.050 inches.

7. A method of increasing the on-machine time of a ganged cutter used on a dicing saw comprising:
installing a ganged cutter in which all components that could have a diameter larger than the blades are erodible;
dressing the blades with an abrasive that erodes the components.

8. A method of assembling a gang cutter comprising:
stacking annular circular saws and erodible spacers with adhesive between their adjacent surfaces around an expanding mandrel;
expanding the mandrel to align the circular saws and erodible spacers along a central axis;
applying pressure until the adhesive cures;
allowing the mandrel to return to size and removing it from the gang cutter.
